(19) United States
(12) Patent Application Publication
(10) Pub. No.: US 2024/0058776 A1
(43) Pub. Date: Feb. 22, 2024

(54) GYROSCOPIC LIQUID SAMPLE MIXER

(71) Applicant: Leandro Jose Agostini, Porto Alegre (BR)

(72) Inventor: Leandro Jose Agostini, Porto Alegre (BR)

(21) Appl. No.: 18/266,990

(22) PCT Filed: Apr. 20, 2021
(86) PCT No.: PCT/BR2021/050164

§ 371 Date: Jun. 13, 2023

(30) Foreign Application Priority Data
Dec. 30, 2020 (BR) 10 2020 027072 9

(51) Int. Cl. B01F 29/00; B01F 29/322; B01F 33/81

(52) U.S. Cl. CPC B01F 29/40353; B01F 29/322; B01F 33/813

(57) ABSTRACT

Mixer comprises a cabinet (1a) with upper lid (2a) and rear support (3) with fixed pulley (4) and drive motor (5), on whose axis the rotor (6a) is mounted. Rotor base (6a) receives a bearing (9) for turning of cup holder (7). Rotor disk (6a) has two side flaps for rollers (10) of the rotation belt (11a) of the cup holder (7) which has a shaft (12) and bearing (9) fastened on the rotor base (6a). Pulley (14) provokes the turning of cup holder (7) by way of the belt (11a). Cup holder (7) is a hollow cylinder with eccentric turning that cause strong agitation of the recipient with liquid. Turning movement of the cup holder (7) occurs on the two shafts which employ only one belt (11a). Mixer has two or four cup holders (7) and one or three tensioner rollers (16) on rotor base (6b) or (6c).

### FIELD OF THE INVENTION

The present invention pertains to the technology sector of liquid homogenizing systems, more specifically refers to a mixing machine for samples of recipients of small volumes to be used, for example, by the tintometric industry, which is based on the homogenization of components by way of the gyroscopic movement of the sample. The proposal presented in the present invention is to carry out quality homogenization of products in small volume recipients by way of a compact machine that is easy to operate.

### STATE OF THE ART

The gyroscopic movement is defined as the rotation of a component in its axial direction, combined with the rotary movement on an orthogonal axis, and may be or not in its center of mass, depending on the application.

This type of movement presents excellent results in the homogenization of liquid products of low and medium viscosity and even of high viscosity products, increasing the operating time, in recipients of various geometric shapes.

Traditionally the industry, especially the tintometric industry, uses mixing equipment with this type of large-scale movement, since the paints generally fall into the viscosity and density scale of these products.

However, the mixers are presented to the market as large and heavy equipment, applied for packaging sizes that vary, for the most part, between 1 and 30 liters.

An example of constructive form of the equipment currently used, which features the drawbacks referred to above, is in U.S. Pat. No. 5,507,575, whose system relies on dishes to accommodate a variation of large packages in a large and robust framework, with equal drive to provide the gyroscopic movement. Due to the size and mass of the equipment, this system does not present versatility, besides being endowed with high consumption alternating current motor, configuring additional drawbacks to that mentioned above.

Patent WO 2016166738 A2 proposes equipment for homogenization of smaller recipients. However, it reproduces orbital movement of the recipients and uses a drive large scale alternating current motor, again requiring a large structure and, consequently, resulting in high weight and little versatility.

For homogenization of small-volume packaging there is a deficiency in the supply of a versatile and quality product. Furthermore, adaptations in large traditional equipment for use on small packages do not bring satisfactory homogenization results.

### OBJECTIVES OF THE INVENTION

The gyroscopic liquid sample mixer, object of the present invention, improves the traditional constructive form for application in the homogenization of products in general, mainly for the tintometric industry. The mixer of the invention performs quality homogenization of small quantities of liquid products produced, for example, by mixing a base and concentrated colorants, by the tintometric system, or other combinations of products, according to other types of systems or methodologies.

The gyroscopic sample mixer of the invention comprises a cabinet with a lid, a rear support with a fixed pulley and a drive motor (5), on whose axis is mounted a rotor consisting of a vertical disk and an orthogonal base, where the cup holder with the liquid to be mixed is fastened. The base rotor has a bearing for axially turning the cup holder. The rotor disk has two small side flaps with rollers that guide and transmission by a drive belt of the axial rotation of the cup holder.

Therefore, this innovative arrangement allows with a single drive to run a gyroscopic movement, that is, a rotation according to a horizontal axis and simultaneously according to a vertical axis.

The mixer of the invention has smaller size and mass such that it is comfortably accommodated in easily accessible counters or tables, excluding the need for an extremely dedicated location for its allocation.

This mixer dispenses with the use of high power electric sockets, since it uses low power drives, meaning it can be used in any common power outlet.

Interaction with user easily occurs with a single trigger button, which starts the mixer cycle after checking the appropriate sensors and operates for the pre-set time on your firmware. The interface is not limited to this configuration alone, and can be adapted or extended for derivations as needed by the end user.

Accordingly, the present invention has autonomy to operate with quality in homogenizing small volume fluid products, occupying little space, presenting energy efficiency through low electrical consumption, easy operation and transportation.

### ADVANTAGES OF THE INVENTION

The gyroscopic mixer for samples, object of the present invention, results in the following advantages over mixers of the state of the art:

it has smaller size and mass such that it is comfortably accommodated in easily accessible counters or tables, excluding the need for a dedicated location exclusively for its allocation;

it dispenses with the use of high power electric sockets, since it uses low power drives, meaning it can be used in any common energy outlet, with low power consumption and consequent energy savings;

possibility of homogenization of small volume liquid products;

more effective homogenization by gyroscopic movement associated with eccentric rotation of the cup recipient, performing rotations on the horizontal axis (of the motor) and on the vertical axis (of the cup, concentric or eccentric);

due to the size and mass smaller than the usual ones, it has the possibility of portability of the equipment;

thanks to simple connections and its reduced size, this equipment is easy to maintain;

it has reduced production and operation cost due to size reduction, energy savings and ease of installation and maintenance;

adaptable for volumes between 10 and 500 mL.

### DESCRIPTION OF THE DRAWINGS

In order for the present invention to be fully understood and brought into practice by any technician in this technology sector, it is now described clearly, accurately and sufficiently [fully], based on the accompanying drawings listed below, which illustrate embodiments of the gyroscopic liquid sample mixer.

FIG. 1—perspective view of the mixer for plain samples positioned in its cabinet;

FIG. 2—perspective view of the mixer for plain samples without the cabinet;

FIG. 3—perspective view of the mixer for plain samples without the rear support;

FIG. 4—blown up perspective view of the mixer for plain samples;

FIG. 5—front view of the mixer for plain samples;

FIG. 6—sectional side view of the mixer for plain samples, according to line AA indicated in FIG. 5;

FIG. 7—perspective view of the mixer for double samples positioned in its cabinet;

FIG. 8—perspective view of the mixer for double samples without the cabinet;

FIG. 9—perspective view of the mixer for double samples without the rear support;

FIG. 10—blown up perspective view of the mixer for double samples;

FIG. 11—front view of the mixer for double samples;

FIG. 12—sectional side view of the mixer for double samples, according to line AA indicated in FIG. 11;

FIG. 13—sectional side view of the mixer for double samples, according to line BB indicated in FIG. 11;

FIG. 14—perspective view of the mixer for quadruple samples positioned in its cabinet;

FIG. 15—perspective view of the mixer for quadruple samples without the cabinet;

FIG. 16—perspective view of the mixer for quadruple samples without the rear support;

FIG. 17—blown up perspective view of the mixer for quadruple samples;

FIG. 18—front view of the mixer for quadruple samples;

FIG. 19—sectional side view of the mixer for quadruple samples, according to line AA indicated in FIG. 18;

FIG. 20—sectional side view of the mixer for quadruple samples, according to line BB indicated in FIG. 18.

### DETAILED DESCRIPTION OF THE INVENTION

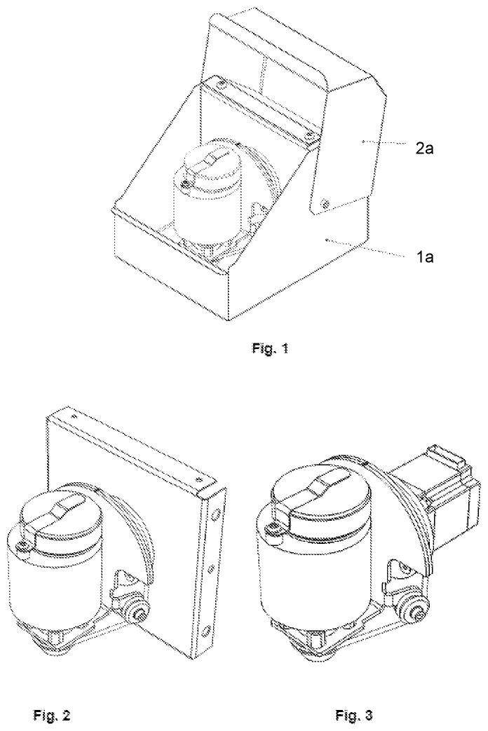

FIG. 1 illustrates the gyroscopic plain sample mixer in its cabinet (1a) where, preferably, not limited to this sole configuration, an upper lid (2a) is present. The cabinet (1a) comes in the shape of a small box, open at the top face, with a rear support (3) vertically oriented.

FIGS. 2 and 3 detail the mixer assembly, which has a fixed pulley (4) on the rear support (3) and a drive motor (5), on whose shaft the rotor (6a) is mounted, comprising a vertical disk and an orthogonal base, where the cup holder (7) is fastened. Therefore, when the motor (5) is driven, the rotor (6a) performs a rotary movement according to a horizontal axis.

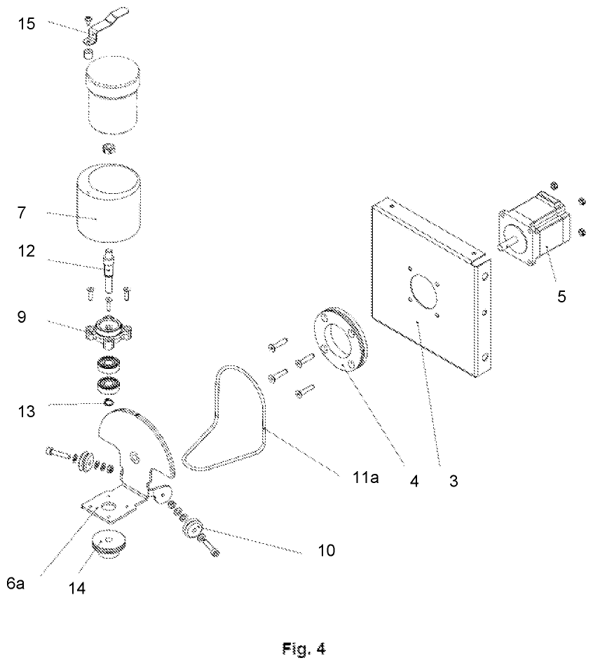

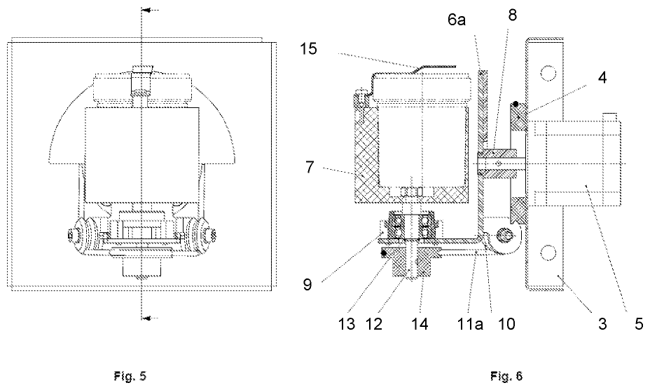

FIGS. 4 to 6 better detail the mixer assembly, whose drive motor (5) has a cross hole in its shaft for positioning the bushing (8) of the rotor (6a), performing the axial and radial locking of the mixer by a through-screw.

The base rotor (6a) receives a bearing (9) for axial turning of the cup holder (7). The rotor disk (6a) has two small side flaps, folded backwards with a certain angle, near its fold line. On the side flaps of the rotor (6a) rollers (10) are fastened to guide and transmit a drive belt (11) of the rotation of the cup holder (7).

The bearing (9) for axial turning of the cup holder (7) is fastened on the rotor base (6a). The cup holder (7) has an axis (12) to drive its axial swivel which is mounted on the bearing (9) fastened on the rotor base (6a). The shaft (12) has a channel for fitting an elastic ring (13) for axial locking.

A pulley (14) provokes the drive of the turning of the cup holder (7) by way of the torque transmission belt (11). The cup holder (7) resembles a pot, but its inner diameter is eccentric and concentric with the positioning hole and shaft fastening, such that the recipient rotates axially eccentrically. The recipient (15) lock is mounted on its top.

The drive belt (11) runs through the entire circuit that passes through the fixed pulley (4), roller (10) of the rotor (6a), drive pulley (14) of the cup holder (7), again on the roller (10) opposite the rotor (6a) and, lastly, returning to the fixed pulley (4). This innovative arrangement allows a single drive to transmit the gyroscopic movement to the recipient positioned in the cup holder (7).

The mixer drive is not limited exclusively to the circular section pulley (11) that can be replaced by “V” section belts, toothed, or even an O'ring ring, provided that they present the appropriate adjustments in the grooves of pulleys, steering wheel and rollers.

The closing of the fairing, preferably, not limited by this sole configuration, is by an articulated lid (2a) on two side holes of the cabinet (1a).

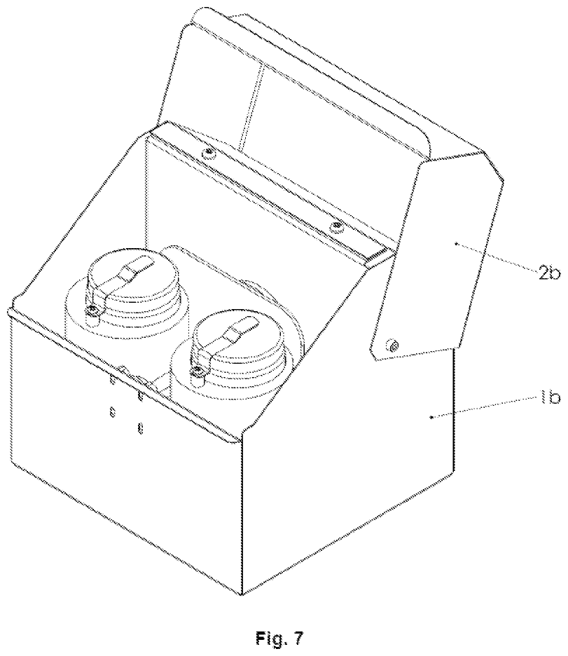

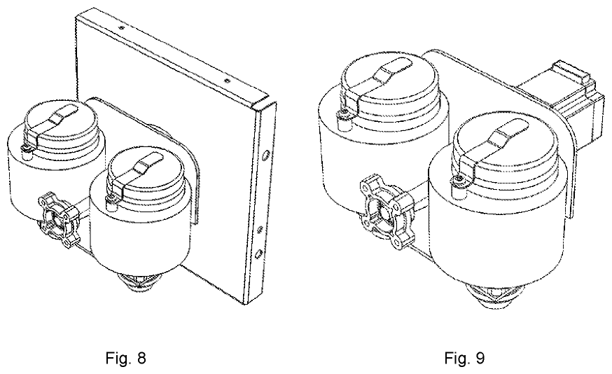

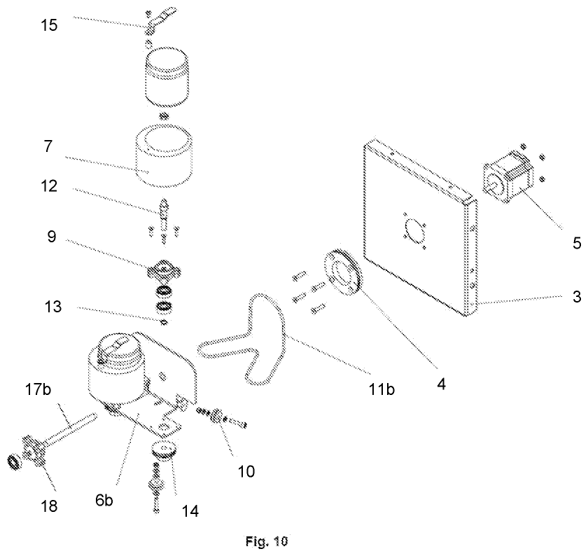

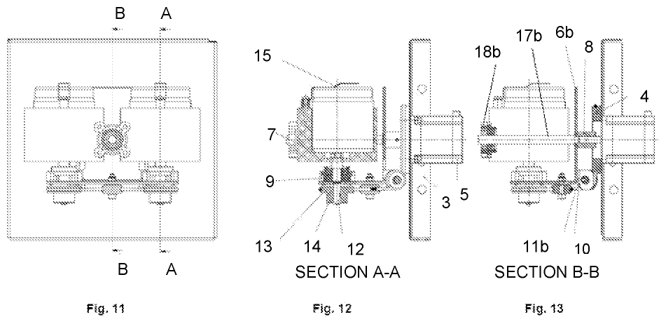

FIGS. 7 to 13 illustrate a first constructive option of the mixer which is double, that is, for simultaneous performance on two cup holders (7). In this constructive option, the rear support (3) and the rotor (6b) are wider, its base being endowed with two bearings (9) for axial swivel of the cup holders (7). A tensioner roller (16) is positioned in the center of the rotor base (6b) and is designed to make the belt (11b) involve to a greater degree the drive rollers (10) of the turning of the two cup holders (7).

In this constructive option, the cabinet (1b) and its corresponding lid (2c) are wider, in order to receive the two cup holders (7). The drive belt (11b) is longer, as its path is longer, passing through the fixed pulley (4), roller (10) of the rotor (6b), drive pulley (14) of the first cup holder (7), tensioner roller (16), in the drive pulley (14) of the second cup holder (7), again in the roller (10) opposite the rotor (6b) and, lastly, returning to the fixed pulley (4). This constructive arrangement further comprises a prolongation (17b) if the shaft of the motor (5), which contains at the end a bearing (18) coupled to the cabinet (1b), guaranteeing the stability of the turning of the shaft of the motor (5), even with adding mass and shifting the center of gravity by adding cup holders (7). This innovative arrangement allows a single drive to transmit the gyroscopic movement simultaneously to the two recipients positioned each one in its respective cup holder (7).

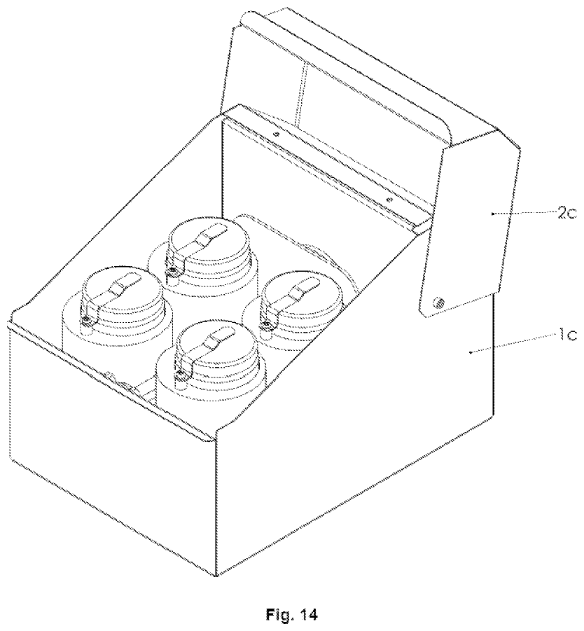

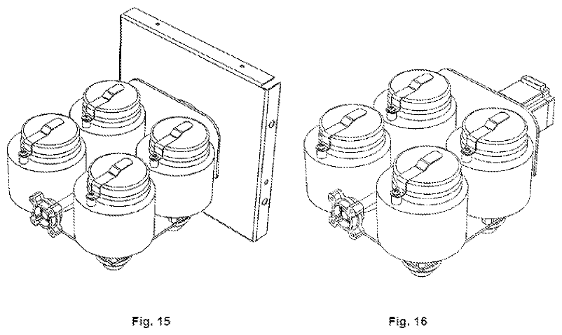

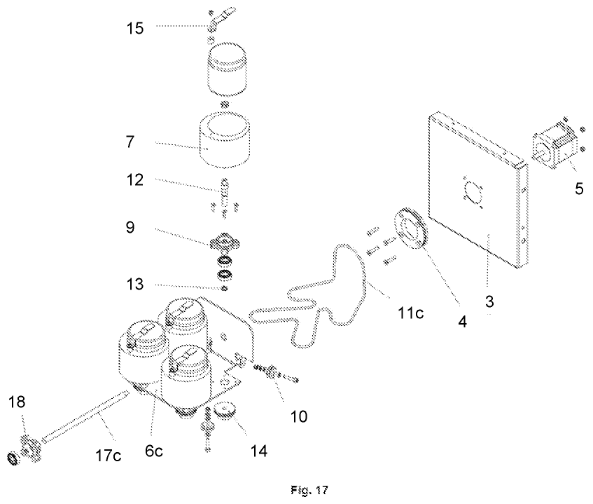

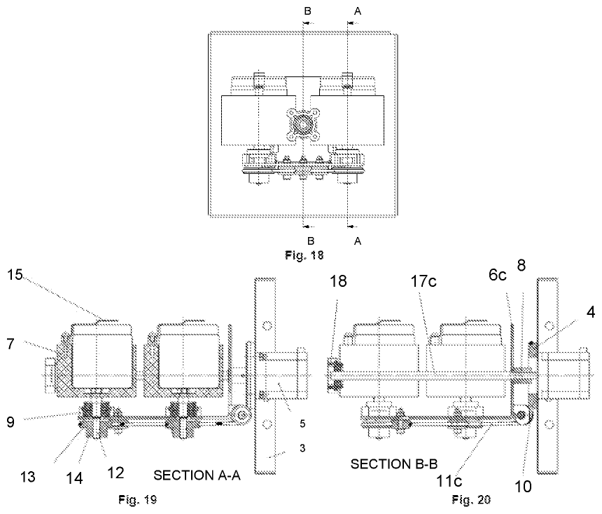

FIGS. 14 to 20 illustrate a second constructive option of the mixer which is quadruple, that is, for simultaneous performance on four cup holders (7). In this second constructive option the rear support (3) and the rotor (6c) are wider and deeper, its base being endowed with four bearings (9) for axial turning of cup holders (7). Three tensioner rollers (16) are positioned on the base rotor (6c) and are intended to make the belt (11c) involve to a greater degree the rollers (10) of the turning drive of the four cup holders (7).

In this second constructive option, the cabinet (1c) and its corresponding lid (2c) are wider and deeper, in order to receive the four cup holders (7). The drive belt (11c) is even longer, as its path is longer, passing through the fixed pulley (4), roller (10) of the rotor (6c), drive pulley (14) of the first cup holder (7), first tensioner roller (16), on the pulley (14) of the second cup holder (7), on the second tensioner roller (16), on the pulley (14) of the third cup holder (7), on the third tensioner roller (16) on the pulley (14) of the fourth cup holder (7) and again on the roller (10) opposite the rotor (6) and, lastly, returning to the fixed pulley (4). This constructive arrangement further comprises a prolongation (17c) of the shaft of the motor (5), which contains at the end a bearing (18) coupled to the cabinet (1c), guaranteeing the stability of the turning of the shaft of the motor (5), even with adding mass and shifting the center of gravity by adding cup holders (7). This innovative arrangement allows a single drive to transmit the gyroscopic movement simultaneously to the four recipients positioned each one in its respective cup holder (7).

It is emphasized that the drawings and description presented are not intended to limit the embodiments of the inventive concept now proposed, but to illustrate and render comprehensible the conceptual innovations disclosed by the invention. Therefore, the descriptions and drawings should be interpreted in an exemplary as opposed to a limitative manner, and there may be other equivalent or analogous forms of implementation that must be considered within the scope of the present invention.

The present specification refers to a gyroscopic liquid sample mixer that results in a new technical effect in relation to the state of the art, thus proving its novelty, inventive activity, descriptive sufficiency [full disclosure] and industrial application, meeting all the requirements for the grant of a patent of invention.

1. A gyroscopic liquid sample mixer comprising a cabinet with an upper lid, where inside there is mounted a rear support having a fixed pulley and a drive motor including a rotor being mounted on the drive motor (5) axis having a vertical disk and an orthogonal base, being fastened on a rotor base a bearing for axial swivel of a cup holder and the rotor and the cup holder being driven simultaneously by a at least one belt, wherein the rotor includes two small side flaps for fastening one or more drive rollers for guiding and transmission of the drive belt of the rotation of the cup holder, wherein the cup holder includes a shaft for performing axial turning which is mounted on the bearing fastened on the rotor base and having a drive pulley responsive to the cup holder by way of the torque transmission belt.

2. The mixer according to claim 1, wherein the shaft comprises a channel for fitting an elastic ring for axial locking.

3. The mixer according to claim 1, wherein the cup holder comprises a hollow cylinder with an inner eccentric diameter and having a recipient lock on its top.

4. The mixer according to claim 1, comprising two of said cup holders, the rotor base having two of said bearings for axial turning of the cup holders, and a tensioner roller that is positioned in the center of the rotor base which makes the belt engage to a greater degree the drive rollers of the swivel of the two cup holders and having prolongation of the shaft of the motor and a bearing (18) at the end of the prolongation, the bearing at the end of the prolongation being coupled to the cabinet.

5. The mixer according to claim 1, comprising four of said cup holders, the rotor base having four of said bearings for axial turning of the cup holders, having three tensioner rollers that are positioned on the rotor base which make the belt to a greater degree the drive rollers of the turning of the four cup holders and having prolongation of the shaft of the motor and a bearing at the end of the prolongation, the bearing at the end of the prolongation being coupled to the cabinet.
